(19) United States
(12) Patent Application Publication
(10) Pub. No.: US 2016/0018236 A1
(43) Pub. Date: Jan. 21, 2016

(54) ELECTRONIC SUBSTITUTE BUS DRIVER SYSTEM

(71) Applicant: Larry F. VAUGHN, Indiana, PA (US)

(72) Inventor: Larry F. VAUGHN, Indiana, PA (US)

(73) Assignee: Zen-Tinel, Inc., Indiana, PA (US)

(21) Appl. No.: 14/613,338

(22) Filed: Feb. 3, 2015

Related U.S. Application Data
(60) Provisional application No. 62/025,763, filed on Jul. 17, 2014.

(51) Int. Cl. G01C 21/36; G01S 19/13

(52) U.S. Cl. CPC G01C 21/3629; G01S 19/13

(57) ABSTRACT

An electronic substitute bus driver system for school buses to provide improved student safety and student control. The system includes (1) a music module for broadcasting soothing music through a speaker system on the school bus during transit, (2) an announcement module for selectively announcing instructions and student drop off locations through the speaker system, wherein the announcement module automatically overrides the music module, (3) a GPS system integrated with the announcement module to provide the student drop off locations and bus routing information, and (4) a route selection module integrated with the GPS system for providing bus routing information to the driver.

### TECHNICAL FIELD

The disclosure is directed to electronic devices and in particular to systems and devices that assist bus drivers, particularly in order to improve student safety on school buses.

Student behavior on school buses has become a growing problem. The school bus drivers are expected to not only drive the bus safely, but also maintain decorum on the buses. A significant problem in the school bus industry arises when substitute drivers are used. Substitute drivers are not familiar with the bus routes. Accordingly, such substitute drivers currently must use written directions to follow the bus route which creates a very unsafe condition for the students. The substitute bus driver must divide his attention among A) traffic conditions, B) what is going on inside the bus, and C) stopping at the correct locations to pick up or discharge students from the bus. Until now, the substitute bus drivers referred to written instructions with regard to the stops made by the bus. Such written instructions took the driver's attention away from the road, and reduced the driver's ability to manage student behavior/conduct on the bus, thus increasing the hazards of driving a school bus.

At the beginning of each school year, drivers are trained on how to handle certain situations on the school bus, such as trip inspections at the start and end of a bus route, emergency procedures, student behavior, etc. If over 200 bus drivers are being trained, each driver perceives such instructions differently which leads to a unique style of executing such instructions. However, the driver's interpretation does not always conform to standards required by the school district. Therefore, a system is required to create a consistent environment on the bus for both the drivers and students which leads to better control of student behavior, improved focus of the driver, and increased confidence of substitute drivers—three factors that can dramatically improve student safety.

In view of the foregoing, an embodiment of the disclosure provides an electronic substitute bus driver system for school buses to provide improved student safety, student control and consistent training for bus drivers. The system includes (1) a music module for broadcasting soothing music through a speaker system on the school bus during transit, (2) an announcement module for selectively announcing messages and student drop off locations through the speaker system, wherein the announcement module automatically overrides the music module at a specific location, (3) a global positioning system (GPS) module integrated with the announcement module to provide the student drop off locations and bus routing information, and (4) a route selection module integrated with the GPS module for providing bus routing information to the driver.

An advantage of the system is that the software and hardware tell the bus driver where to stop and what turns to make thereby eliminating the need for a substitute bus driver to refer to written instructions.

### BRIEF DESCRIPTION OF THE DRAWINGS

FIG. 1 is a schematic drawing of the system of an embodiment of the disclosure.

FIGS. 2-6 are exemplary screen shots of various input and output screens for the system described herein.

### DETAILED DESCRIPTION OF EXEMPLARY EMBODIMENTS

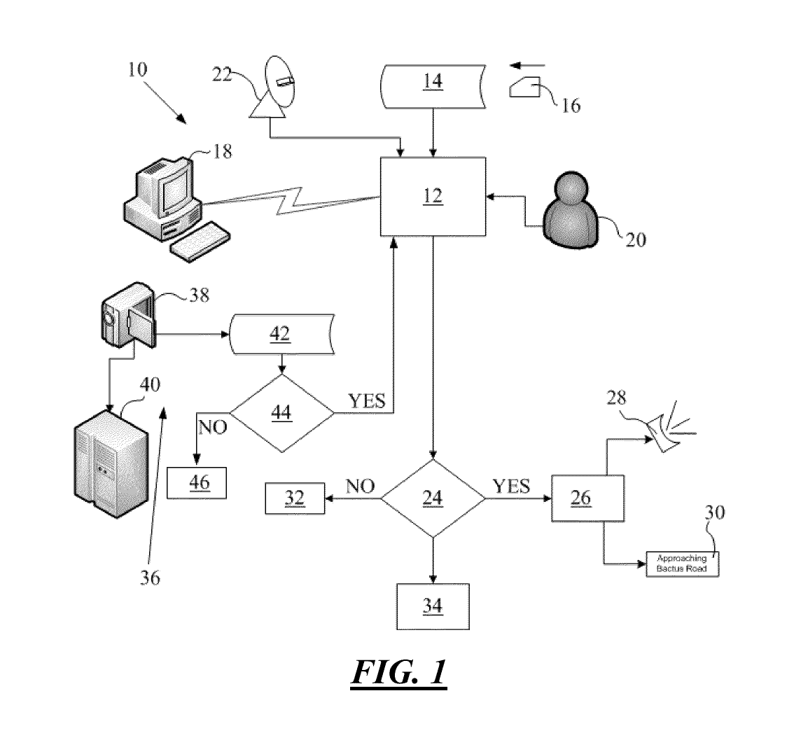

A system 10 according to the disclosure is illustrated schematically in FIG. 1. The system 10 includes operational software residing in a computing module 12. The computing module 12 may include a data storage unit 14 for route data storage. A removable storage device 16, such as thumb drive, solid state storage device, SDcard, or CFcard, may be used to change the route data or the route data may be input wirelessly from a main frame terminal 18. A bus driver 20 may select the route from a menu of routes provided by the computing module 12. The route may also be selected by the computing module from a time and location of the bus which may be determined by a global positioning system (GPS) module 22.

When a predetermined bus location 24 is reached, an announcement module 26 is activated to give the location, stop or other information to the students and driver through a speaker system 28 on the bus. In an alternative embodiment, a visual display 30, such as an LED screen, in view of the students inside the bus may be used in combination with the audio announcement system to visually display the location, stop or other information. In between stops, a music module 32 provides soothing music through the speaker system. When the final location 34 is reached, the system is shut down.

### Music Module

The music module of the system plays background music from .wav or .mp3 files. The music is selected to be soothing music to keep the students calm during the bus ride. In one embodiment, the music may be provided as delta wave which is preferred for the calming effect, but other types of music may be used. At specific GPS locations, the system automatically pauses the background music or fades the music out and plays a specified message from a .wav or .mp3 file. The location for playing the message is activated by GPS coordinates in the GPS module. The coordinates can be determined either through a passive GPS system or an active GPS system. When the message is complete, the music will automatically start playing again.

The basic concept of the music module is that the module plays selected audio clips when the bus is near a particular location. For example, near a railroad crossing the device would play audio saying “Railroad crossing ahead; prepare to stop.” Under the primary mode of operation, the software will parse a “route” file filled with waypoints defined in latitude and longitude coordinates. When the data coming in from the GPS module indicates that it is within x radius of the current point, the software will play the associated audio file and check the waypoint off the list.

The device may be configured through an internet (Web) application that provides an interface to the main configuration file, route files, and audio files. In the alternative, the system may be configured offline with a .csv file using MICROSOFT EXCEL. The system supports route recording using the web based interface and an attached GPS in the GPS module. GPS waypoints can be created and labeled by a rider while a driver is driving the route. Once a route is recorded, waypoints may be edited, removed, or assigned to a specific audio announcement using the Web interface or offline using MICROSOFT EXCEL.

Dual audio systems may be used with the music module to provide (1) an audio file to the bus driver that gives routing and stop information to the bus driver through a speaker adjacent to the bus driver, and (2) an audio file that plays music or announcements for the students through a separate speaker system.

The system may store multiple routes for a single bus, corresponding to multiple bus route assignments. The bus driver can scroll through the stored routes with a push button and select the desired route.

The system may also be configured to automatically choose a default route to start based on current GPS position or time. Accordingly, it is unnecessary for the bus driver to select a route—the correct route will be selected based on the current location and time (if designated). The GPS module may also be configured to give specific turn-by-turn directions to the bus driver.

The system supports file transfer protocol (FTP) for a transportation company or school to ‘push’ a daily announcement to the music module component or to periodically change the announcements on the bus. For example, a bus route can be set to play a daily announcement when entering the school grounds. The school can transfer a new announcement to the system over a wireless or wifi connection daily to change the content of the announcement. The wifi connection gives specified individuals in authority the ability to record messages specific to the particular bus. The messages may be automatically downloaded to the correct bus. When the bus gets close to the school or drop off point, the message assigned to the bus will be played. Messages may include, but are not limited to, activities of the day or week which include things such as tests, sporting events, etc.

The primary hardware may be a GECM-9G25 Embedded CPU Module to be used with a GECB-9GX5 Evaluation Carrier board. The hardware provides two UART ports for RS232 communication, one of which is broken out to a DB9 connector. One of the ports is connected to the GPS module. ZEN-TINEL and REDTAIL GPS units are supported by the system. The software accepts NMEA compatible strings or a similar module.

The main circuit board is designed for a 5 v power supply and may be powered through a 12 v to 5 v converter supply. The board also contains pins for GPIO and analog audio, an Ethernet port, and two USB ports. Buttons/LED Indicators may be connected to the GPIO pins. In addition, a USB port or card slot may be provided on the board for file transfer purposes. The software may use a storage device such as a microSD card, thumb drive, or solid state hard drive to store audio files and configuration data. Analog audio pins are available for left and right audio output channels.

A “Route Select” button is provided with the system to enable the bus driver to switch between routes. In addition to the “Route Select” button, the bus driver may activate an “Operator Mode” button to allow different modes of operation, e.g. play more audio information for substitute bus drivers. A “Reset” button is provided to cause the software to remove all checklist states and begin again at the current route without having to toggle power to the system. A “Power” indicator LED is provided to alert the driver that the device is operational. When the bus is on the selected route, an “On Route” indicator LED will be activated. If the driver deviates from the selected route an alarm will sound and/or the “On Route” indicator LED will be deactivated.

To configure the system, a user may either take out the microSD (or other storage device) and replace the configuration files through a file explorer or interact with a Web Application hosted by the device. The system is designed for access to a wired network, however, the AP client may transparently put the device on the wireless or wifi network if the wired network is not available. A network manager screen is provided to configure the IP address information of the device. The default IP to reach the network manager screen is 192.168.1.5. Each unit of the system may be configured with a unique IP address for the purpose of loading different routes or announcements to each device.

The system software is designed to operate on the ANGSTROM LINUX distribution operating system. It loads from an onboard flash that will need to be re-flashed to add our software and any operating system level tweaks. A compressed file system (tar.gz) is provided for the software. To flash an existing system, all that needs to be done is to input a file into a running board, un-tar the filesystem, and reboot. The operating system is configured to start the main application automatically upon bootup and run continuously until the power is shut off. In the alternative, any other suitable operating system may be used to operate the system software.

The software operating system will first parse the system configuration file. The file is named “config.csv” and may be located on the root of a FAT32 formatted microSD card. Two pieces of information are configured, namely, the vehicle identifier and GPS baud rate. More fields may be added through the use of commas as the field delimiter. As a consequence, no commas are allowed in the Vehicle Identifier or any other field. A header at the top of the file will provide a description of the fields, so that it may be easily parsed in MICROSOFT EXCEL. More fields may be added to the software such as “Audio Volume.”

The software system will then parse the route selection file. The route selection file is named “select.csv” and is located on the root of the microSD card. The purpose of the route selection file is to provide parameters to identify which route to automatically select when the application is in idle mode (either done with a route or upon startup). The radius is given in feet, and time is UTC in the format hh:mm:ss. The software application will depend on the GPS for the current time. If the current time is within the time range, within the radius of the specified point, and the associated route file exists, the software application will select that route. If there are no matches, the software system will remain in idle mode. At any time, the bus driver may press the “Route Select” button to select a route manually. Once a route is selected, the software will parse the file into an internal data structure and run the main loop.

Most school districts and contractors have software that is used to determine the best routes for the buses. The system is configured to interface with bus routing software, such as EDULOG, VERSATRAN, TRANSFINDER, etc, or with internet based mapping software. Accordingly, routing software may be overlaid onto the system software in order to capture the bus stop latitude and longitude which become the trigger points to stop the music and start the messaging. If routing software is not available, the route may be driven and the stops manually input into the system software for each trigger point. The route selection file may also contain turn-by-turn directions as well as specific stops.

The route file may contain Latitude (in signed degrees format), Longitude (in signed degrees format), Detection radius (in feet), Route Waypoint type (integer), Audio file name to play, and miscellaneous notes. The Route waypoint type of ‘0’ indicates that the point is a breadcrumb. A breadcrumb will not play audio and is only there to help with route synchronization. Any other use of a breadcrumb point is purely organizational. Some names like “Bus Stop” are given in the web interface for organizational purposes.

The software may continuously parse data from the GPS module and determine if the bus is within any unchecked waypoint defined in the route file. If there are two or more matching waypoints, only the first waypoint is used. If the current bus location matches the current waypoint, the corresponding audio file is played (if any). The waypoint is marked “checked,” and the current waypoint moves to the next line. The “On Route” indicator LED will continue to show green. This is the standard behavior; the rest of the algorithm attempts to handle odd cases in the most graceful way possible.

If the current bus location matches an unchecked waypoint a little way forward (less than (3) waypoints), the algorithm assumes there was a GPS module problem. The software will check off the skipped waypoints and play the audio file for the current point (if any). No audio will be played for the skipped waypoints. The current waypoint will move to the next line.

If the current bus location matches an unchecked waypoint a long way forward or backward, the software algorithm assumes a possible change in the route. A “Resynchronizing” indicator LED will turn on and the waypoint will be marked “visited.” If there are (3) consecutive forward waypoint matches, then a route change will occur. A route change will turn off the “Resynchronizing” LED, change the current waypoint to the matched one, mark all visited waypoints as checked, and mark any unvisited and unchecked waypoints as “skipped.” If there are any skipped waypoints that are not breadcrumbs, the “On Route” LED will begin to flash.

If the current location matches a skipped waypoint, the waypoint will be checked off and any corresponding audio will be played. The current waypoint will not change. If there are no more remaining skipped waypoints that are not breadcrumbs, the “On Route” LED will stop flashing and stay lit.

When all waypoints that are not breadcrumbs are checked off (the route is finished), both LEDs will turn off and the system will enter an “idle mode.” Once in idle mode, the system will begin looking at the route selection file for eligible routes to select.

If the “Reset” button is pressed at any time, all route states will be discarded and the current waypoint will point to the first line again.

If the “Route Select” button is pressed at any time, all route states will be discarded and a new route file will be parsed. The file will be (Vehicle Identifier) route(X).csv where X indicates the next valid route number available (up to 255). If no file with a higher route number is available, it will loop back to 1. When the file that is to be loaded is found, the software will play route(X).wav where X indicates the route number. The preloaded .wav files will be announcements of “Route One” etc. If no route file is found, the system will indicate a general state of error by continuous flashing of both LED indicators. The software activates the music module to continuously play the background music “background.mp3” unless a waypoint audio file is to be played.

The software will host an HTML website that will render in almost any internet browser. The website may be reachable over the network connection. There may be seven application pages, including the following, a File Manager, Network Manager, System Manager, Selection Manager, Route Manager, Route Recorder and Route Follower. All internet screens include a navigation bar at the top.

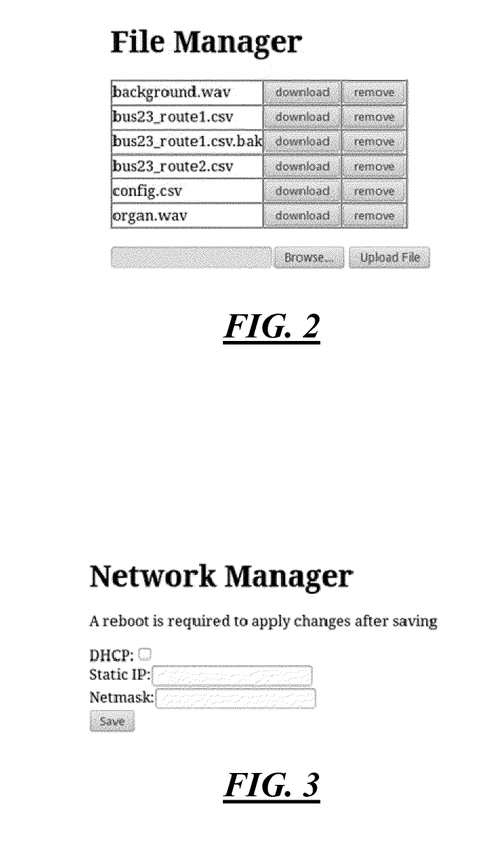

The File Manager screen will allow the user to upload/download/remove system configuration file, selection file, route configuration files, and audio files. An exemplary screenshot of the File Manager screen is shown in FIG. 2.

The Network manager screen will allow the user to reconfigure the ethernet settings. By default the IP address is 192.168.1.5. Once the ‘Save’ button is clicked, a reboot is required to see the changes take effect. An exemplary screen shot of the Network Manager screen is shown in FIG. 3.

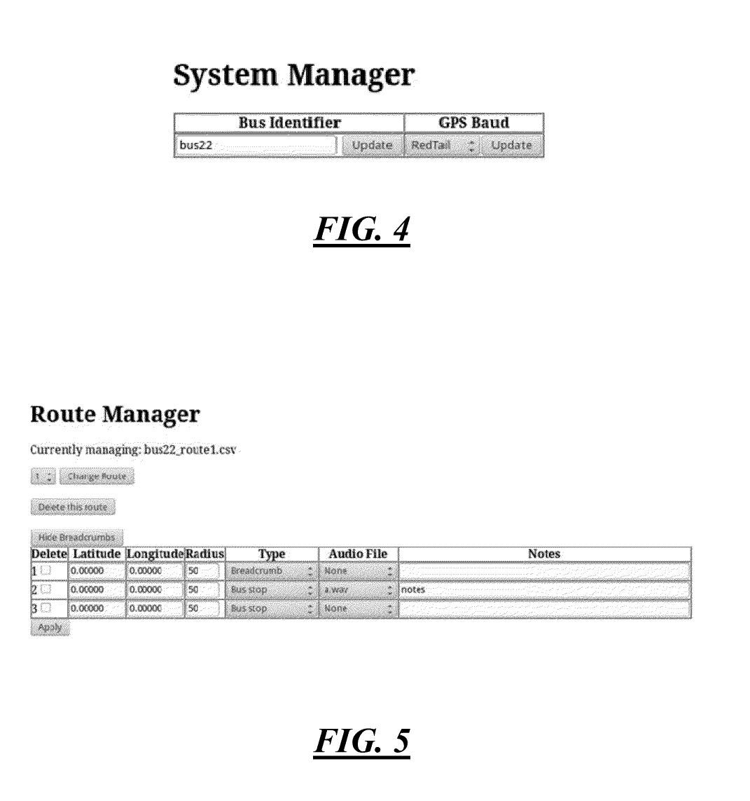

The System Manger screen will provide a graphical interface to the fields of the system configuration file with the ability to modify the file and save a new file. The GPS Baud field contains ‘ZEN-TINEL’ and ‘REDTAIL’ choices, corresponding to 4800 and 9600 baud rates. An exemplary screen shot of the System Manager screen is shown in FIG. 4.

The Selection Manager will provide a graphical interface to the fields of the route selection file with the ability to modify the files and save a new file. Along with editable fields, the route Selection Manager screen will contain checkboxes to indicate deletion of rows and an “Add” checkbox that will add a new row to the end when “Apply” is clicked.

The Route Manager screen will provide a graphical interface to the fields of the currently selected route file. The Route Manager screen will contain a dropdown box to select a route file, a button to delete the current route file, a table of current waypoints with editable fields, a “Delete” checkbox, and an “Apply” button that will save the changes. The type dropdown provides choices between “Breadcrumb” and the following other types that are only organizational at this point: “Bus Stop,” “Route Start,” “Route End,” “'Railroad crossing.” The Audio file dropdown provides choices between all the .wav files available on the microSDcard. An exemplary screenshot of the Route Manager screen is shown in FIG. 5.

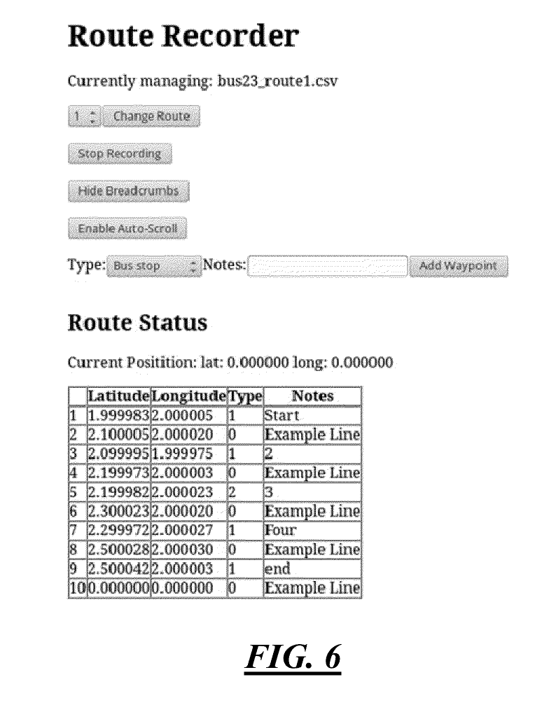

The Route Recorder screen may enable the user to record breadcrumbs and location specific waypoints to a route file. The Route Recorder screen contains a dropdown box to select a route file, a field to Add a route, a button to “Start Recording”, a button to Hide/View breadcrumbs in the table, a button to Enable/Disable auto scrolling, a form for adding a waypoint at the current location with notes and type, and a table displaying the current route file (just Lat., Long., Type and Notes). The breadcrumbs will only start recording once a starting waypoint is added manually. A breadcrumb is added once the current location is far away from the last waypoint (15 times its radius). An exemplary screen shot of the Route Recorder screen is shown in FIG. 6.

The Route Follower is used primarily for debugging purposes. The Route Follower shows the current location and the most recent output of the main application.

Non-limiting examples of system announcements and directions are provided below:

### Morning Route

1. Good morning, please complete your pre trip inspection at this time. Thank you and have a great day.
2. Driver, your first stop is located at 1515 Hillside Drive at 6:15. Please check your time.
3. Music
4. Attention students: For your safety, please remain seated at all times and keep your voice down. Classroom behavior is expected on this bus at all times. Thank you. (Repeat in Spanish) repeat every 7 minutes.
5. Music
6. Attention Students: We are approaching a railroad crossing; please remain silent at this time. Driver, please activate your silent switch at this time.
7. Students we are approaching your destination. Please stay in your seats and start gathering your personal belongings.
8. Have a nice day here at St. James Elementary School.
9. Attention Driver: Please check your bus for sleeping students at this time. Once completed, continue on your next route. Your first stop is located at 1744 Hwy 544 at 7:30 a.m. Please check your time.

### Evening Route

1. Good afternoon, please complete your pre-trip inspection at this time. Thank you.
2. Good afternoon students, please stay in your assigned seats and keep your voices down. Classroom behavior is expected on this bus at all times.
3. Music
4. Students: we are approaching bus stop located at 1515 Hillside Drive. Please remain in your seat until the bus comes to a complete stop. When exiting, please follow the driver's instruction and wait on the driver's signal before crossing the road. Thank you. (repeat in Spanish if needed)
5. Music
6. Attention Driver: Please veer right on to Hwy 544. Your next development is Deerfield Plantation.
7. Students: we are now entering Deerfield Plantation. If this is your development, please stay in your seat and start gathering your personal belongings at this time. Thank you
8. Driver: Your next stop is located at 112 Deerfield. This stop has 2 students that require parental supervision. Please make sure supervision is available before students depart. Thank you.
9. Driver: your turn about location is approaching at Bactus Road on right. Please follow your proper procedures before backing. Thank you.
10. Attention Driver: You just completed your last stop; please check your bus for sleeping students at this time.
11. Driver: Please complete your post trip inspection and check your bus for sleeping students. Thank you and have a nice evening.

### Emergency Procedures

1. Attention students: we will now review the emergency exits and procedures. Please remain quiet and pay attention to the driver's demonstration.
2. In the event of an emergency, remain calm and locate one of the emergency exits. An alarm will sound when any of the emergency latches are disengaged.
3. For your safety, never open an emergency exit while the bus is moving.
4. To open the front door, move the yellow handle above the door from normal mode to emergency mode and push the door outward.
5. The first aid kit and fire extinguisher are located at the front of the bus in the compartment above the stairs.
6. To use the emergency window exit, pull up on the red handle and push the window outward.
7. To use the emergency exit on the roof, turn the red knob and push to release the hatch.
8. To use the back emergency exit, pull the handle up and push the door outward. When using a side or back door exit, sit on the floor first and then jump out of the bus.
9. The first two students to exit the bus should remain at the exit to help the other students jump down.
10. After exiting the bus, line up single file on the sidewalk and wait for the driver's instruction.
11. Leave everything on the bus.
12. This concludes the review of emergency exits and procedures. Please pay attention to the driver for further instructions.

### Safety Procedures

1. Students: upon exiting the bus, please be alert and check your surroundings. Remember to look both ways and make sure that all traffic has stopped before crossing the road.
2. Always cross in front of the school bus at a safe distance. If you can't make eye contact with the driver, you are too close to the bus.

Field testing of the system has shown that it significantly improves discipline on the bus. For example, over a three month period, the write ups for bad behavior on the bus had decreased by 30%. The system was also found to be effective in improving the communication between the bus driver and the students.

In addition to the modules described above, the system is configured to support a video/audio module 36 for a video camera 38 and video/audio recorder 40 for the bus (FIG. 1). The video camera 38 and recorder 40 may be a backup video camera/recorder or the primary video camera/recorder for the bus.

The software system may include word recognition software and is configured to recognize either specific words or decibel levels that may indicate a bullying incident. Specific bullying words may be input to a database for the system to use in automatically identifying bullying events. When a bullying incident occurs, a notification is sent to the video recorder, and a video segment is marked for later review. A 20 second video/sound clip may be sent to the appropriate school office for review at the time of the incident. In the alternative, the marked event may be automatically downloaded to the principal's computer when the bus returns to the school or bus terminal, eliminating the need to review all of the video recorded on the bus. In the alternative a notification that an event is occurring or has occurred may be sent to the principal using 4G technology. The principal may have the ability to view the event in real time or to remotely access the recorder and review the marked event.

The system may also include storage media module 42 for storing a database of information regarding all of the students that ride the bus (FIG. 1). Accordingly, when the student gets on the bus, their picture may be taken by an optional camera module 38 and compared by comparison module 44 to a picture of the student stored in the database. If a match is made by the comparison module 44, a notification may then be sent back to a base operation facility by means of the computing module 12 to notify the facility that the student got on the bus. When the student gets off of the bus, the system will also send notification to the base operation facility that the student got off. Accordingly, if a student gets on the incorrect bus, an alarm module 46 is activated to provide a location of the student and to indicate what corrective action is to be taken if necessary.

It is contemplated, and will be apparent to those skilled in the art from the preceding description and the accompanying drawings, that modifications and/or changes may be made in the embodiments of the disclosure. Accordingly, it is expressly intended that the foregoing description and the accompanying drawings are illustrative of exemplary embodiments only, not limiting thereto, and that the true spirit and scope of the present disclosure be determined by reference to the appended claims.

What is claimed is:

1. An electronic substitute bus driver system for school buses to provide improved student safety and student control comprising:
a music module for broadcasting soothing music through a speaker system on the school bus during transit,
an announcement module for selectively announcing instructions and student drop off locations through the speaker system, wherein the announcement module automatically overrides the music module,
a global positioning system (GPS) module integrated with the announcement module to provide the student drop off locations and bus routing information to the bus driver, and
a route selection module integrated with the GPS system for providing bus routing information to the driver.

2. The system of claim 1, further comprising a daily announcement module for providing time sensitive information to students during transit.

3. The system of claim 2, wherein the daily announcement module further comprises a wifi interface for intercepting and broadcasting the daily announcements as the bus approaches a school.

4. The system of claim 1, wherein the route selection module further comprises multiple routes and a selection button for selectively choosing one or more of the routes.

5. The system of claim 1, wherein the bus routing information is automatically provided by the route selection module based on a starting location of the bus.

6. The system of claim 1, further comprising an input module and a storage module for selectively inputting music, bus routes, drop off locations, and announcements into the announcement and music modules.

7. The system of claim 1, further comprising a video module for recording students as they get on the bus.

8. The system of claim 7, wherein the video module further comprises a comparison module and student data base for confirming students are on the correct bus.

9. The system of claim 7, wherein the video module further comprises a bullying event recognition system for identifying and marking bullying events for review and corrective action.

10. The system of claim 1, wherein the announcement module comprises both audio and video output devices.
